(19) United States
(12) Patent Application Publication
(10) Pub. No.: US 2026/0086831 A1
(43) Pub. Date: Mar. 26, 2026

(54) ARTIFICIAL INTELLIGENCE TECHNIQUES TO CREATE OR UPDATE DATA MODELS

(71) Applicant: MicroStrategy Incorporated, Vienna, VA (US)

(72) Inventors: Zhili Cheng, Dunn Loring, VA (US); Mohamed Diakite, Vienna, VA (US); Bikan Tan, Vienna, VA (US); Jaime Alberto Perez, Brambleton, VA (US)

(21) Appl. No.: 19/334,285

(22) Filed: Sep. 19, 2025

Related U.S. Application Data
(60) Provisional application No. 63/697,297, filed on Sep. 20, 2024.

(51) Int. Cl. G06F 9/451; G06F 17/11

(52) U.S. Cl. CPC G06F 9/451; G06F 17/11

(57) ABSTRACT

Methods, systems, and apparatus, including computer-readable media, for artificial intelligence techniques to create or update data models. In some implementations, the system stores records describing each of a plurality of different functions that can be performed in a data processing system. The system receives a user prompt that indicates a type of data object to be created. The system selects records for a subset of the functions based on the user prompt. The system sends a request to be processed by one or more artificial intelligence and/or machine learning (AI/ML) models. The system receives output of the one or more AI/ML models that defines an additional data object. The system uses the output of the one or more AI/ML models to cause a user interface to be updated or to update a data model.

### CROSS-REFERENCE TO RELATED APPLICATIONS

This application claims the benefit of priority to U.S. Provisional Patent Application Ser. No. 63/697,297, filed on Sep. 20, 2024, the entire contents of which is incorporated herein by reference.

### BACKGROUND

The present specification relates to techniques for determining and revealing interpretations made by models for artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system can be configured to use artificial intelligence or machine learning (AI/ML) models to create or update data models. For example, the system can provide a chat-style interface (e.g., a chatbot interface) that a user can use to request for an additional metric or other data object to be created. The system can then use an AI/ML model, such as a large language model (LLM) to generate a definition of the new metric. The system can guide the AI/ML model by adjusting the context of the AI/ML model to the existing data model or characteristics of the data sets the user is working with. The system can provide the AI/ML model data from the current data model or data schema, for example, a list or definition of the attributes, metrics, tables, columns, or other objects that can be referenced. With this information, the system can guide the AI/ML model to create a formula for a metric using references to data elements that exist in the user's data set(s). The system can also perform processing to validate the metrics that the AI/ML model generates. If the output of the AI/ML model does not meet the validation requirements, then the system can identify errors or flaws and automatically initiate one or more follow-up interactions with the AI/ML model, so the system and the AI/ML model can correct any errors and potentially obtain an appropriate metric iteratively.

In systems that use databases, data warehouses, and other types of data storage, data modeling is often an important task to make the various types of stored data accessible and usable to users and applications. For example, a data model can include a data schema or metadata that specifies logical objects represented in one or more data sets. This can include a list of the elements or components of the data set, such as metrics, attributes, facts, and so on, where these objects may represent columns of data or aggregations or the results of calculations performed on columns on data. For example, an attribute often refers to a particular database column that provides data of a certain type (e.g., time, date, customer identifier, street address, employee phone number, etc.). A metric often refers to a set of values that may be calculated based on the values in one or more columns of a database table, and which may include data aggregations or other operations applied. In general, a data model can describe data objects that are represented in, or can be derived from, data in the data set.

In many cases, it is useful to define metrics or other logical objects that go beyond the values actually stored in a database. For example, if a database has columns or tables that respectively store measures for multiple geographical regions (e.g., Region 1 Inventory, Region 2 Inventory, etc.), it can be useful to define a metric that aggregates these into a single measure (e.g., Total Inventory, across all regions). As another example, a metric may apply any of various functions to other objects or columns of data, such as to a metric “Profit” that is defined as the value from a “Revenue” column minus the value of a “Costs” column. A vast number of different types of metrics can be generated using different combinations of other objects in a data set, and with different functions or relationships being applied. The metrics can be defined with formulas or other relationships of the source data, so the values of the metric can be calculated or refreshed by the data processing system as the underlying source data changes.

Users often desire to create new metrics that fit their particular needs or use cases, which can vary significantly from user to user, role to role, and company to company. However, generating metrics is often a complex task due to the large number of potential functions that can be applied and the large number of source elements (e.g., existing attributes, metrics, columns, etc.) in a data set. The large number of possibilities and the need to create valid expressions often results in users creating metrics that have invalid references or do not accurately provide what a user intends. In addition, LLMs and other AI/ML models can also struggle to accurately create useful metrics without appropriate guidance and validation checks, due to the large number of functions that are available and the non-standard identifiers and labels that are used differently in each different data set. Many AI/ML models are susceptible to providing hallucinations when answering user prompts, and a metric definition that includes a hallucinated or otherwise erroneous reference would produce a non-functional or inaccurate metric.

The present system provides users an interface that enables them to initiate the creation of new metrics for a data model through a simple natural language interface, such as a chatbot-type text messaging interface. The system obtains the user's text prompt describing the desired metric and the system supplements the user's prompt with important information that guides the AI/ML model to valid references and to the most likely functions that satisfy the user's request. For example, the system can gather important context that directs or limits the AI/ML model to generate output that references (1) valid functions that can be applied to perform calculations (and the correct names or labels for those functions) and (2) valid data set objects that exist in the current data model and/or in the source data set(s) corresponding to the data model. In order to guide the AI/ML model and increase the likelihood that the newly generated metric is correct, the system can perform an initial selection of functions from among the overall library of functions that a database system can perform. The system can then provide function definitions or function guides for a limited subset of functions that the system determines to be most relevant or most similar to the operation requested in the user's prompt. The system can also supplement the user's prompt with additional instructions to the AI/ML model, such as by specifying the response format, limiting the data set objects used to those specified in the provided data model, and so on. These and other techniques discussed below enable the system to generate metrics much more reliably and accurately than a LLM could normally generate based on a text prompt from a user.

The system can perform a variety of validation checks to review the output of the AI/ML model, detect errors, and correct a metric if errors are present. For example, it is important that the formula or expression that the AI/ML model generates for the new metric validly reference functions and data objects, so those references can be resolved and used in the database system. The system can examine the content that is output by the AI/ML model, parse the content to identify functions and data set objects mentioned, and verify that these reliably and unambiguously map to valid functions and data set objects. In addition, the system can examine the newly defined metric with respect to the actual data values to verify that the functions are applied to appropriate types of data and produce results of an appropriate type (e.g., a user's request for a count or percentage has a new metric that returns the requested type) or in an appropriate range of values. If the system detects an error, the system can automatically initiate one or more additional cycles of interaction between the system and the AI/ML model, often enabling the system to correct the metric without the need to involve or notify the user. This can further increase the reliability and accuracy of the metrics that are created, because the system can detect and correct many errors that an AI/ML model may make, such as invalid references to data set objects (e.g., ambiguous references or references to objects that do not exist) or inappropriate function usage (e.g., incorrect function for a data type, invalid parameters for a function, unknown function referenced). As a result, the system can provide reliable and accurate metrics that reference unique, customized data sets, even with the potential inaccuracies and probabilistic nature of LLMs.

As a data model is edited and expanded, more data set objects are available to be used as source objects for defining new metrics. The process of creating a new metric coordinated by the system can adapt and make these new data set objects available to the AI/ML model as the data model is progressively updated and expanded.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users'confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user.

For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In one general aspect, a method performed by one or more computer comprises: storing, by the one or more computers, records describing each of a plurality of different functions that can be performed in a data processing system; receiving, by the one or more computers, a user prompt that indicates a type of data object to be created; selecting, by the one or more computers, records for a subset of the functions based on the user prompt; sending, by the one or more computers, a request to be processed by one or more artificial intelligence and/or machine learning (AI/ML) models, wherein the request includes (i) the user prompt, (ii) the selected records for a subset of the functions, and (iii) data indicating data objects for one or more data sets; receiving, by the one or more computers, output of the one or more AI/ML models that defines an additional data object, wherein the output (i) refers to one or more of the data objects indicated in the request and (ii) specifies a relationship for calculating a value of the additional data object based on one or more values of the one or more of the data objects; and using, by the one or more computers, the output of the one or more AI/ML models to cause a user interface to be updated to indicate the additional data object or to update a data model for the one or more data sets to include the additional data object.

In some implementations, the user prompt is a text instruction or request to create a metric, and the user prompt indicates a type of data for the metric to represent.

In some implementations, storing the records comprises storing, in a vector database, a separate record for each of the different functions; and selecting the records for the subset of the stored functions comprises selecting a subset of the records based on vector similarity for one or more portions of the user prompt and one or more portions of the records.

In some implementations, the relationship for calculating the value of the additional data object comprises a formula or expression.

In some implementations, the formula or expression specifies a mathematical operation to be performed on data of one or more data objects for the one or more data sets.

In some implementations, the records for the plurality of different functions indicate, for each function, syntax for the function and arguments or inputs for the function.

In some implementations, the records for the plurality of different functions indicate, for each function, an operator or symbol for the function and a description of the function's effect.

In some implementations, the records for the plurality of different functions indicate, for each function, one or more examples of correct usage of the function.

In some implementations, the one or more examples for a function include one or more pairs of requests and resulting valid formulas generated using the function.

In some implementations, the request includes an additional instruction to provide a name, description, and formula for the additional data object; and the output of the one or more AI/ML models includes a name for the additional data object, a description of the additional data object, and a formula for calculating values of the additional data object.

In some implementations, the request includes an instruction to generate the additional data object using the data objects indicated in the request, which are data objects in a data model for the one or more data sets, and not rely on data objects that are not in the data model.

In some implementations, the request includes an instruction to select one of the functions indicated in the request and use the selected function to generate the additional data object.

In some implementations, the method includes: performing, by the one or more computers, a validation process for the additional data object indicated by the output; determining, based on the validation process, that the additional data object does not satisfy one or more rules or criteria for data objects; and in response to the determination, initiating an additional interaction with the one or more AI/ML models to request a correction or adjustment to the additional data object.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for using artificial intelligence or machine learning (AI/ML) techniques to create or update data models.

FIGS. 2-7 are diagrams showing examples of user interfaces that show techniques to create or update data models.

Like reference numbers and designations in the various drawings indicate like elements.

### DETAILED DESCRIPTION

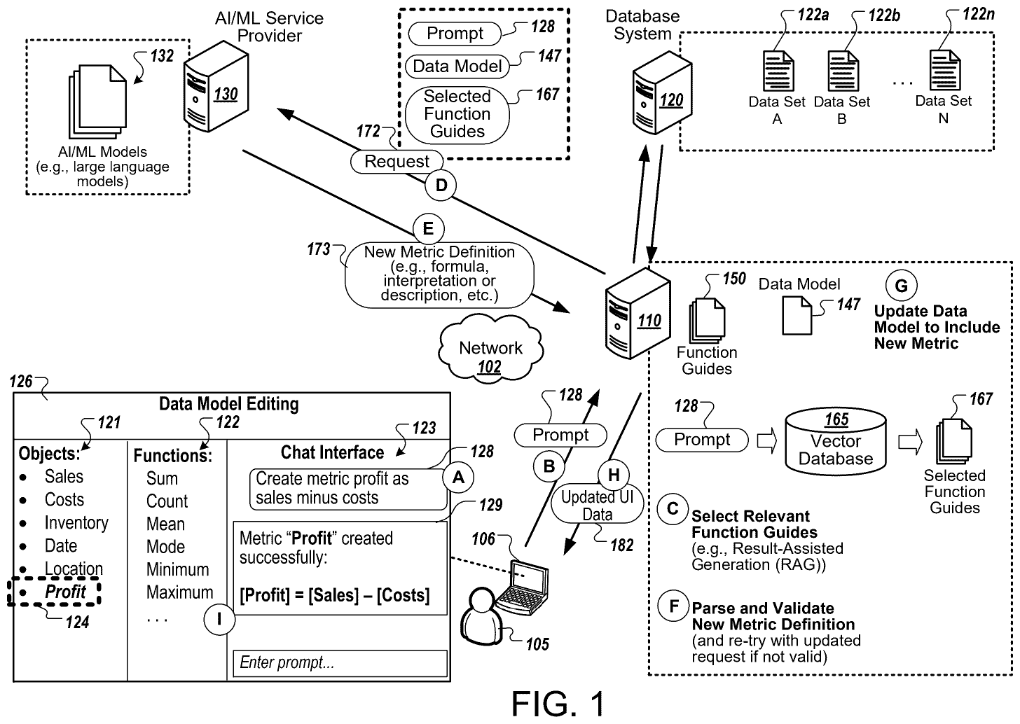

FIG. 1 is a diagram showing an example of a system 100 for using AI/ML techniques to create or update data models. The system 100 includes a computer system 110, a database system 120, and an AI/ML service provider 130. The system also includes a user device 106 of a user 105. The elements of the system 100 communicate over a network 102, such as the Internet. The computer system 110 coordinates a variety of operations to provide and manage access to documents, as well as chatbots and other AI/ML applications. The computer system 110 can also provide tools and interfaces that enable a data architect, administrator, or other user to generate or edit data models, including to create new metrics that involve the application of functions or operations to one or more data objects (e.g., one or more columns of data from one or more data sets).

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as relational database tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

Different users have access to different datasets 122a-122n and documents, depending on their roles, permissions, etc. The user 105 authenticates to the computer system 110, so that the user's identity is determined and the user's permissions can be determined.

For each data set 122a-122n, the computer system 110 can store or access a corresponding data model. In some cases, the data models may not have a one-to-one relationship with the data sets 122a-122n, for example, a data model may include information that spans or relates to multiple data sets 122a-122n.

A data model can include information about the data objects in or derived from a data set 122a-122n, such as the attributes, metrics, columns, or other objects in the corresponding data set. The data model can provide a list of these data object, as well as specify the name or identifier for the data object, the object type (e.g., attribute vs. metric), a relationship or formula to lookup or derive values of the data object from a data set 122a-122n, and other properties. A data model can also specify relationships between data object, semantic meanings or descriptions of data objects, parameters for using data objects, and so on.

As an example, a particular data model 147 can include a data schema for the data set 122a. In general, the data model 147 can indicate a list of logical objects represented in the data set 122a, such as a list of the elements or components of the data set, such as metrics, attributes, facts, and so on. For example, the data model 147 can indicate that the data set 122a includes logical objects such as date, customer identifier, region code, sales amount, revenue, costs, profit, and so on. These data objects can represent quantities or data objects that are represented in, or can be derived from, data in the data set 122a. The logical objects, such as metrics or attributes, can represent the type of data that is stored in or derived from one or more column of data in the data set 122a. For example, an attribute may represent a type of data stored in a column of a data table or the result that would be obtained by applying a particular arithmetic expression to data in a column. Similarly, a metric can represent the result of applying a particular aggregation function or other operation(s) to values in one or more columns of a data table. Accordingly, the data model 147 can indicate the attributes and metrics that are available for the database system 120, an AI/ML model 132, or another application to work with. For example, the database system 120, an AI/ML model 132, or another application may refer to the data model 147 to resolve references to data objects and identify which portions of the data set 122a (or calculation results based on the data set 122a) can be obtained.

Beyond the particular columns of data stored in the data set 122a, there can be additional attributes or metrics that can be generated. For example, the application of a function to an existing metric can be defined as a new metric, which can be saved in the data model 147 for later use by other users, as well as by the database system 120, AI/ML models 132, applications, and so on. Many different functions or operations are available for the database system 120 to apply to data to define new attributes or metrics.

In some cases, the data model 147 can indicate, through the logical objects it identifies, data from tables, columns, and other elements that make up the data set 122a, potentially with the semantic meanings and/or relationships among these elements of the data set 122a. For example, the data model 147 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way.

As discussed below, the data model 147 can be provided to an AI/ML model 132 to enable the AI/ML model 132 to appropriately interpret and make reference to the appropriate logical data objects related to the data set 122a or potentially other data sets 122b-122n. Providing the data model 147 can give the AI/ML model 132 a list and description of the logical data objects that the database system 120 recognizes, so that content generated by the AI/ML model 132 appropriately maps identifiers and other terms to the correct interpretation (e.g., particular metrics, attributes, columns, tables, etc.).

The example of FIG. 1 shows a user 105 (e.g., a database architect, an administrator, a data analyst, etc.) that has a client device 106 displaying a user interface 126 for editing the data model 147. The user interface 126 can be for an application, web application, web page, or other interface for the user 105 to interact to add and edit data objects in the data model 147. The user interface 126 can support the user 105 directly defining data objects, such as by typing or otherwise entering a formula that specifies operations that produce a new metric to be added to the data model 147. The user interface 126 also includes features that support the creation of metrics through a more automated approach that uses one or more AI/ML models 132 to define new metrics from natural language input from the user 105, such as a prompt, request, or question in a chatbot interface.

The example of FIG. 1 shows an example of a process in which the system 100 guides an AI/ML model 132 to define a new, valid metric for the data model 147, that accurately matches the user's intent by selecting an appropriate function and applies it correctly to the proper data objects previously defined in the data model 147. The example of FIG. 1 includes stages (A) to (H), which represent various operations and a flow of data, and which can occur in the order illustrated or in a different order.

In the example of FIG. 1A, in stage (A), the user 105 enters a prompt 128 (e.g., natural language input, such as a question or statement) in a chat interface 123 of the user interface 126. The user interface 126 has several sections, including (1) an object list 121 that shows the objects defined in the data model 147, (2) a function list 122 that shows various functions that can be applied to define new metrics, and (3) the chat interface 123 where the user 105 can make requests to edit or provided information about the data model 147 (e.g., to add a new metric, to edit a metric, etc.).

Initially, when the user 105 submits the prompt, there are five data objects defined, Sales, Costs, Inventory, Date, and Location. The prompt 128 from the user 105 includes the text, “create metric profit as sales minus cost. ” Thus, the user requests to create a new metric with the name “profit,” and that the metric should be defined to be calculated by taking values of the Sales object and subtracting corresponding values of the Costs object. Because the prompt 128 is specified in free-form natural language text, the prompt 128 may use terms to refer to data objects that do not match the official or canonical names or labels for those data objects. As discussed further below, the computer system 110 and/or the AI/ML model 132 can perform various actions to determine the data objects or data set content, that user prompts refer to.

In stage (B), the client device 106 sends the prompt 128 to the computer system 110 over the network 102. The prompt 128 can be sent with additional information that identifies, for example, the user 105, the data model 147 being edited, the current session of the application or user interface 126, and so on.

In stage (C), the computer system 110 performs initial processing of the prompt 128, before sending the prompt 128 to the AI/ML model 132. For example, the computer system 110 may perform keyword analysis or semantic analysis to interpret the general purpose of the prompt 128, such as to request a new metric, to ask for information about a setting, to make a change to a setting of an existing metric, to obtain a list of data objects that have been defined, and so on. When the computer system 110 detects that the prompt 128 calls for a new metric to be defined, the computer system 110 can identify information that can guide the AI/ML model 132 to successfully (e.g., accurately) complete the requested task.

One of the challenges of creating new metrics is the wide variety of different functions that can be applied in a data processing system. In many cases, a data processing system has dozens or hundreds of different functions available, and those functions are available to be applied in creating the formula or expression to define a new metric. The effects and purposes of the different functions are not always clear and there may be nuanced differences among the effects of the functions. It can be very challenging, for a user or for a computer system such as an LLM, to correctly identify which function will achieve a desired result. Moreover, different functions often have different syntax and other requirements, and so even after identifying an appropriate function it can be a challenge to use the function correctly so that the desired results are achieved. Finally, when creating a function, the appropriate data objects need to be selected so that the function(s), when applied, produce the result with the desired significance. The user's prompt 128 may be ambiguous or vague as to which data object should be used, because the user may use a non-standard label or name for the data object (e.g., a misspelling, a nickname, a synonym, etc.).

To increase the likelihood that the AI/ML model 132 will be able to create an accurate metric formula in response to the user's prompt 128, the computer system 110 can perform initial searching or pre-processing to limit the options that the AI/ML model 132 will consider, which can limit the risk of inaccurate choices. This can include the computer system 110 selecting, from the set of functions supported by the database system 120, a subset of the functions that have a meaning or effect that is closest to what the user 105 specified in the prompt 128. This can be done by finding functions that have the highest similarity in topic, concept, or semantic meaning with terms and phrases in the user prompt 128. Similar techniques can also be used to narrow the set of data objects in the data model 147 on which to apply a function to. For example, the computer system 110 can select a subset of attributes and metrics from the data model 147 that have the highest similarity or relevance to the terms and phrases in the user prompt 128.

In further detail, the database system 120 can have a defined set of functions (e.g., operators or calculation types) that can be used in the definition of metrics. Each function can have a defined and standardized usage, syntax, or set of properties (e.g., type, quantity, and order of arguments operated on; keywords that specify the function; an order of items operated on; types of data operated on; etc.). The computer system 110 stores a set of function guides 150 where each function guide 150 corresponds to a different function (e.g., a one-to-one relationship of functions and function guides). For example, each of the functions in the function list 122 can have a corresponding function guide 150. Each function guide 150 can specify information such as a name, operator or symbol, a description of the function's effect, a description of the usage of the function, one or more examples of correct usage of the function, syntax or other properties of the function, contexts or use cases where the function is more likely or less likely to be appropriate, and so on. In some cases, a function guide can include examples not simply of a formula or expression that uses a function, but also pairs of requests and resulting valid formulas generated using the function, which can help show an AI/ML model 132 relationships between terms used in prompts and the correct usage of the function. In general, the function guide 150 for a function can include the information that explain to an AI/ML model 132 the meaning of a function, its effects, and how to use it correctly.

In many cases, it is not effective or efficient to provide all of the function guides 150 to the AI/ML model 132. For example, there may be hundreds of functions and thus hundreds of function guides, resulting in a very large amount of data transfer and a very large context length for the AI/ML model 132, which can increase costs, computational resource requirements, and delay in producing answers. In addition, the accuracy can diminish when the option space is high and the AI/ML model 132 only has a brief prompt 128 of maybe only a few words to use in assessing the whole set of functions.

To improve accuracy and improve efficiency, the computer system 110 can select a subset of the function guides 150 to provide to the AI/ML model 132. For example, the computer system 110 can use result-assisted generation (RAG) techniques to select a subset of the function guides 150 with highest relevance or highest similarity to the concepts and terms in the prompt 128. As an example, the computer system 110 can use a vector database 165 or other system that enables conceptual searching or semantic searching. A vector database 165 can store information by representing it with an embedding or position (e.g., projection) in a high-dimensional vector space. The computer system 110 can store information about each of the functions (e.g., the function guides 150, metadata about the functions, common or historical uses of the functions, etc.) in the vector database 165. For example, the vector database can store information such as function names and function guide 150 content. For example, information about a function can be represented with embeddings or positions of the information in a high-dimensional vector space.

To identify the functions relevant to the user prompt 128, the computer system 110 system can also represent the user prompt 128, or separate chunks or portions of the user prompt 128, in the vector space. The computer system 110 can search for information that is conceptually or semantically similar to the terms of the user prompt 128 by comparing the position of the vector representation of user prompt terms with the vector representation of the stored information (e.g., function names, function guide 150 data, etc.). The computer system 110 can identify the functions or function guides that that are closest to the terms of the user prompt 128 in the vector space, and the closest functions and function guides 150 are most similar and relevant to the concepts of the terms in the user prompt 128. In this manner, even if the user prompt 128 includes an incorrect spelling or other non-standard form of reference to a function, the conceptual or semantic search can find functions that are still relevant to the user prompt 128. Through this process, the computer system 110 can determine a subset of the function guides 150 (e.g., fewer than all of the function guides 150) to be a set of selected function guides 167 identified as most similar to the meaning or intent of the prompt 128. The selected function guides 167 may be selected as, for example a particular number of function guides (e.g., the top 3, 5, 10, etc. most relevant function guides), the set of function guides having at least a minimum threshold level of similarity to or no more than a maximum distance from the vector representation of the user prompt 128, etc.

In some implementations, the computer system 110 also uses RAG techniques to narrow the set of data objects that are most relevant to the prompt 128. For example, the computer system can store information about data objects (e.g., data object descriptions, data object names, data object usage examples, data object definitions from the data model 147 or data schema, etc.) in the vector database 165, using embeddings that represent the vector representation or projection of these items onto a vector space. The system can also represent the user prompt 128, or separate chunks or portions of the user prompt 128, in the vector space. The system can then identify the data sets 122a-122n and data objects that that are closest to the terms of the user prompt 128 in the vector space, where the closest data sets 122a-122n and data objects are the most similar to the concepts of the terms in the user prompt. The computer system 110 can then select the most similar data objects (e.g., those with the smallest distance in the vector space) as the most likely candidates for the AI/ML model 132 to use in defining a new metric as requested in the prompt 128. For example, the computer system 110 can select a subset of data objects that is a predetermined number of data objects (e.g., the top 5, 10, 15, etc. data objects), the subset of data objects having at least a minimum threshold of relevance or no more than a maximum distance in the vector space, etc.

In stage (D), the computer system 110 generates and sends a request 172 to the AI/ML service provider 130, for the AI/ML model 132 to generate a response to the request 172. The request 172 can include the prompt 128, the data model 147 indicating available data objects, and the selected function guides 167 identified to be most relevant to the user's prompt 128. The prompt 128 supplies the criteria or instructions for the new metric. The data model 147 specifies the types of data that can be operated on in defining the new metric, e.g., the data object in the data model 147. The selected function guides 167 identify a limited set of functions that are most likely to achieve the goal in the prompt 128, while also explaining (and potentially giving examples of) how to use the corresponding functions accurately.

If the computer system 110 has identified a specific subset of data objects that are the most likely candidates, the computer system 110 can include identifiers for those data objects also, potentially with an instruction to limit the generated formula for the metric to using those data objects. As another example, if a relevant subset of data objects has been identified, the request 172 can provide only the data object definitions for the subset of data objects, rather than the complete data model 147, to limit the range of data objects that will be used.

The computer system 110 can generate the request 172 to include other instructions to the AI/ML model 132 also. For example, the request 172 can specify that the output should be provided in a particular format (e.g., JSON, XML, etc.). As another example, the request 172 can specify that the AI/ML model 132 should provide certain types of information, such as a name for the new metric, a formula or expression for calculating values of the new metric, a text description of the new metric, etc. As another example, the request 172 can instruct the AI/ML model 132 to use the data object identifiers specified in the data model 147 when referring to data items. In some implementations, the request 172 also instructs the AI/ML model 132 to generate a text description or interpretation of the formula that the AI/ML model 132 generates for the new metric, so the interpretation can be provided to the user 105 to help the user 105 understand the result. The request 172 can instruct the AI/ML model 132 to restrict the source data used (e.g., columns, data objects, etc. used in formulas) to the data objects in the data model 147 or other data model content provided (or items derived from those data objects), so that specified data items can be found and used in the database system 120.

In stage (E), the computer system 110 receives generated output from the AI/ML model 132, such as text for a new metric definition 173. The new metric definition 173 can include the various pieces of information requested in the request 172, such as a name, description, formula, and interpretation for the new metric. The new metric definition 173 can refer to data objects existing in the data model 147 using the data object identifiers from the data model 147 or using standard names or labels specified in the data model 147.

As discussed above, the request 172 to the AI/ML model 132 can include instructions (e.g., a system prompt or additional instructions added to the user prompt) that specify to use only data objects that are specified to the AI/ML model 132 (e.g., data objects existing in the data model at the time the request 172 is made). As a result, the new metric definition 173 is often limited to using the existing data objects as arguments or inputs in the new metric definition. In addition, because information from the data model 147 specifying the names and meanings of the existing data objects are provided to the AI/ML model 132, the new metric definition 173 can refer to those data objects by their official names or identifiers in the data model 147, which avoids ambiguity.

Similarly, as discussed above, the request 172 to the AI/ML model 132 can include instructions (e.g., a system prompt or additional instructions added to the user prompt) that specify to use only functions for which function guides are provided with the request 172. This can help ensure that the new metric definition 173 is generated to refer to functions that are actually defined in and usable by the database system 120, and also that the syntax and usage of the functions is correct. In many cases, the new metric definition 173 represents the uses of only a single function, with the AI/ML model 132 selecting data objects from the data model 147 for that function to operate on. In some cases, especially for complex data objects, the metric definition 173 may reflect the application of multiple functions, specified by different function guides.

In stage (F), the computer system 110 performs validation of the new metric as specified by the new metric definition 173 from the AI/ML model 132. For example, the computer system 110 can perform a number of checks to verify that the formula set forth in the new metric definition 173 meets a predetermined set of rules or criteria. If the new metric definition 173 is determined to be valid, then the computer system 110 can add the new metric to the data model 147 or propose the new metric for the user 105 to confirm. If the new metric definition 173 has errors or is otherwise determined to be valid, then the computer system 110 can perform further interactions with the AI/ML model 132 to correct metric definition or create a new, improved metric definition.

The computer system 110 parses the new metric definition 173 to extract the various element (e.g., name, formula, description, interpretation). The computer system further parses the formula or expression, which may be expressed in text or in a structured form, and attempts to map the elements to specific corresponding data objects, functions or operators, and other elements. A first check for the new metric can be to determine whether the computer system can map the specified elements to valid functions and data objects. The rules or requirements can require that mentioned data items correspond to data objects that actually exist, so that references in the new metric definition 173 (whether by identifier or human-readable name) can be resolved unambiguously to specific data objects in the data model 147. A second check for the new metric can be to determine whether the syntax of the functions used is appropriate (e.g., correct input and output data types, order or relationship to specified data objects is present, and so on). A third check for the new metric can include application of the formula to actual data of the data set 122a, to determine if the output is in an appropriate range, does not return null or undefined values, or otherwise meets the criteria for metric values. Other validation checks can also be performed.

If the new metric definition 173 fails one or more validation checks, the computer system 110 can generate an error message that describes the problem (e.g., undefined output, data object name not recognized, ambiguous data object name, etc.). The computer system 110 then generates a new request to the AI/ML model 132 that includes the error message and an instruction to create a new metric definition or correct the earlier metric definition to correct the error. The new request can have, for the context used when the new request is processed by the AI/ML model 132 (e.g., LLM), the content of the request 172 and the new metric definition 173. As a result, the AI/ML model 132 can iteratively correct or update the new metric definition 173, in effective continuing the chat session to progressively update and define the new metric requested by the prompt 128. When the AI/ML model 132 responds, the computer system 110 can perform the validation steps again on the updated metric definition, and can continue to request corrections or re-tries, each time specifying the errors encountered with the most recent version of the metric, until a valid metric is defined or a maximum number of re-try cycles is reached. If the maximum number of attempts is reached without a valid metric definition, then the computer system 110 can provide a response to the user 105 indicating the failure and requesting that the user re-phrase or clarify the request stated in the prompt 128.

In stage (G), after the computer system 110 has verified that the new metric definition 173 meets the validation requirements, the computer system 110 updates the data model 147 to add the new metric. In this case, the new metric is given the label “Profit,” and the formula is defined as the Sales data object minus the Costs data object. The update to the data model 147 makes the new metric, Profit, available to the database system 120 for processing queries and standard query language (SQL) statements, as well as to be shown in visualizations, represented in dashboards or reports, and in other uses. In some implementations, the computer system 110 adds a validated metric to the data model 147 automatically in response to successful validation. In other implementation the computer system 110 provides information about the new metric to the user 105 so the user can view the formula, preview values of the metric, edit the metric if desired, or take other actions before the user confirms that the new metric should be added.

In stage (H), the computer system 110 sends updated data to the client device 106 indicating the new metric, Profit. The user interface 126 is updated to show a response 129 in the chat interface 123. In this example, the response 129 indicates that the metric was created successfully, that the name is “Profit,” and the formula for the metric (referencing data objects with their names in brackets) is also provided. The new metric is also added as a new entry 124 in the data object list 121, where the user 105 can further edit its properties, or later use the Profit metric in creating visualizations, filters, reports, dashboards, SQL statements, and other items.

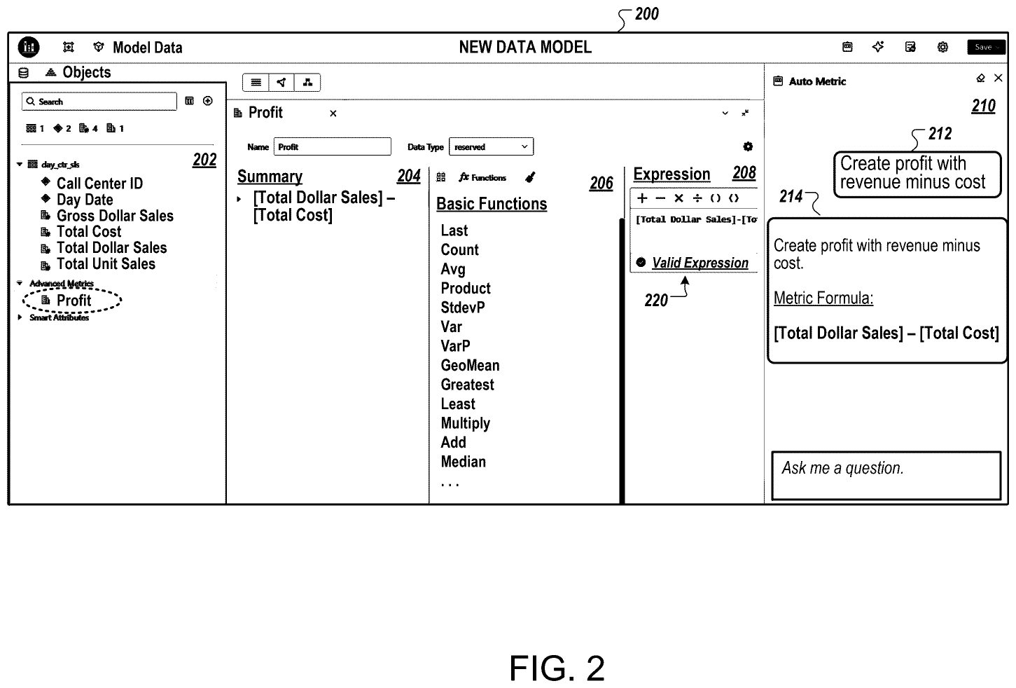

FIG. 2 shows another example user interface 200 that includes features allowing a user to create a metric using a chatbot interface. The example shows a list of data objects 202, a summary area 204 describing a profit metric that was just created, a function list 206, an expression region 208 where the user can edit or otherwise adjust the formula for the profit metric, and a chatbot interface 210. The chatbot interface 210 shows the user's initial prompt 212 as well as the response 214 from the system. In the expression region 208, a validation indication 220 is provided to show the user that the formula is valid.

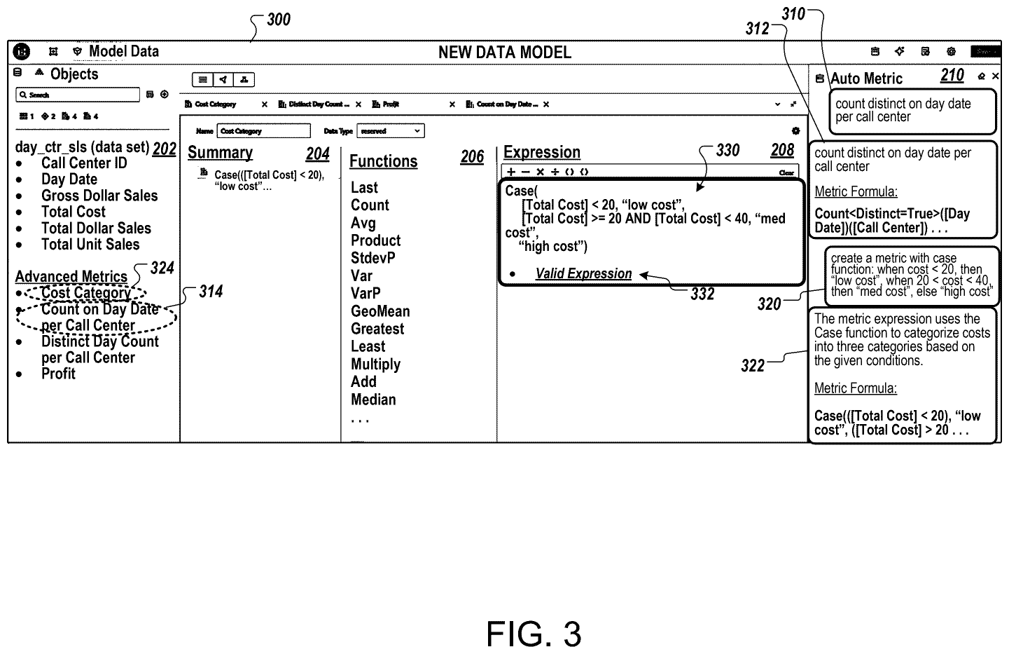

FIG. 3 shows another example of a user interface 300, showing additional metrics that have been added. For example, in the chatbot interface 210, there is a user prompt 310 and a response 312, representing a process to create a metric called “count on day date per call center. ” This metric is shown with an entry 314 in the data object list 202. The example also shows another set of interactions, with a user prompt 320 and a response 322, which were used to create a metric called “cost category,” which has a corresponding entry 324 in the data object list 202. Other portions of the user interface 300 have content that corresponds to the cost category metric. For example, the summary area 204 and the expression area 208 describe the operations used to calculate the cost category metric. The expression area 208 shows a formula 330 for the cost category metric, as well as a validation indicator 332 indicating that the expression is valid. The expression area allows text entry and editing so that the user can change the formula for the metric directly if desired.

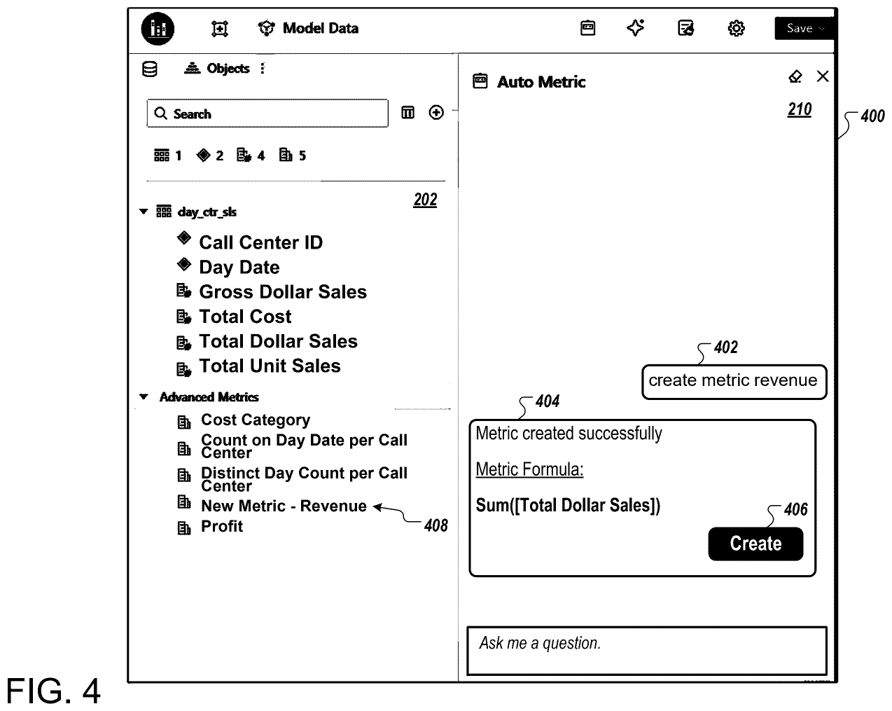

FIG. 4 shows another example user interface 400 that shows data object list 202 and the chatbot interface 210. In this case, the user submitted a prompt 402, “create metric revenue,” and did not specify the specific source data items to use in creating the “revenue” metric. Nevertheless, the operations of the computer system 110 identify the most likely functions to calculate revenue and the most likely data objects related to the concept of “revenue. ” This provides a relatively small set of candidate functions and candidate data objects for the AI/ML model 132 to choose from in generating the metric. In addition, the computer system 110 provides the existing data model, which includes items like “total dollar sales” and the description for this data object. These inputs, together with the user prompts 402 and the language understanding capabilities of the AI/ML model 132 allow the AI/ML model 132 to generate a formula for the metric even with a very limited prompt 402. The result is a new metric that the user can accept interacting with a control 406, and which is listed as an entry 408 in the data object list 202.

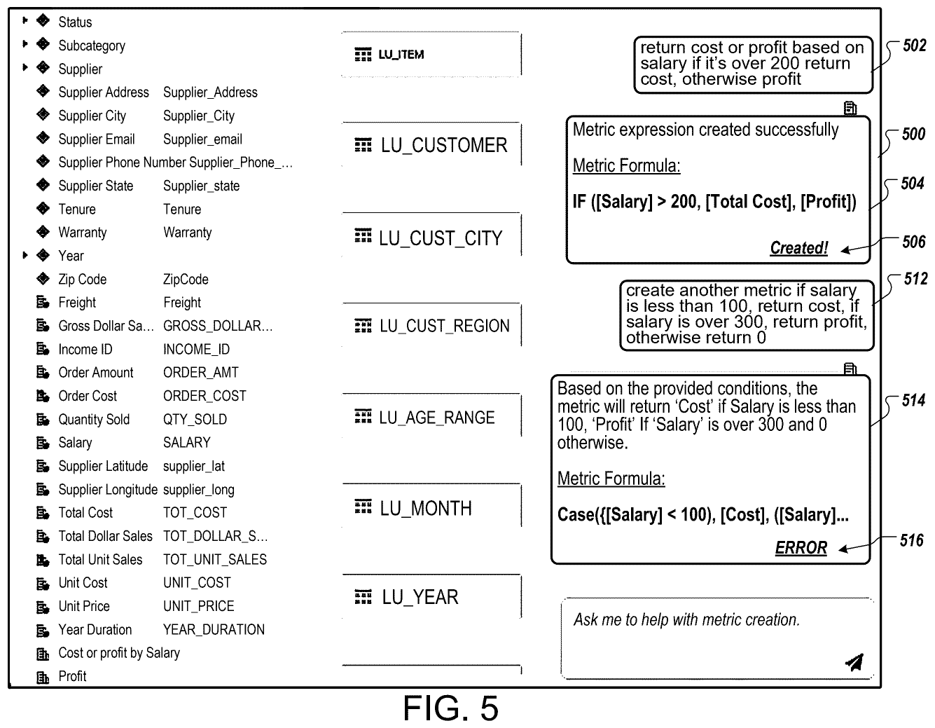

FIG. 5 shows another example user interface 500 used to create metrics though a chat interface. In this example, a first set of interactions, involving a prompt 502 and a response 504, shows a successful validation of the newly created metric definition, as indicated by the validation indication 506. By contrast, the second set of interactions, involving a prompt 512 and a response 514, shows a metric definition that failed validation and so shows an error indicator 516 instead of an indication of successful validation. As discussed above, the computer system 110 can attempt to retry generation of metric definitions if an error or validation failure occurs. Nevertheless, after a predetermined number of retries, computer system can indicate the error to the user so that the user can change the prompt or otherwise change the metric creation process.

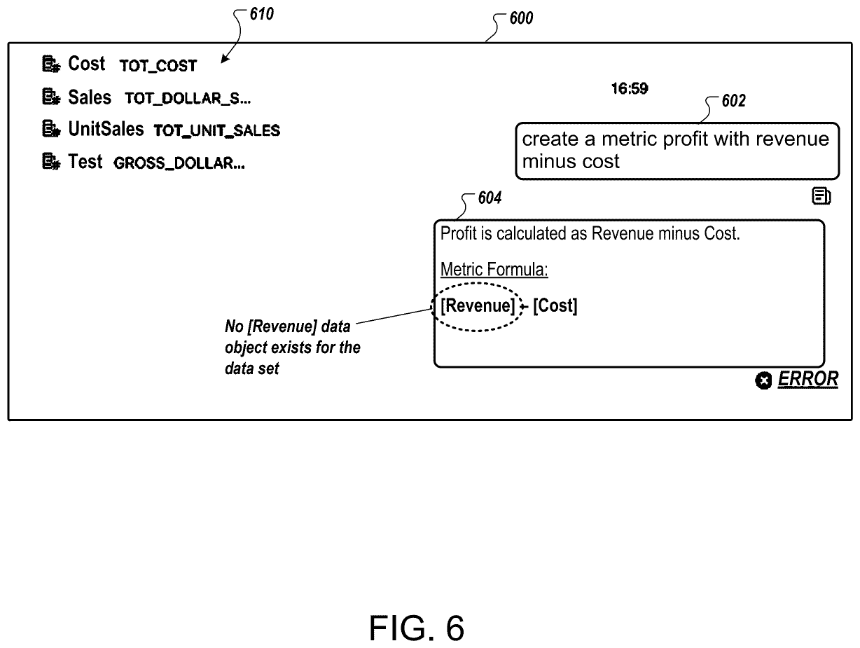

FIG. 6 shows another example user interface 600 showing a data object list 610 and chatbot interactions including a prompt 602 and a response 604. In this example, the response 604 from the AI/ML model 132 includes a formula referring to a supposed data object called “Revenue,” but there is no data object with this name in the data object list 610 or the existing data model. As a result, the computer system 110 identifies that the reference to “Revenue” cannot be resolved (e.g., mapped to a valid data object) and so the formula is invalid. In this case, the AI/ML model 132 overly weighted the term revenue used in the prompt 602, and did not limit the formula to using only the set of data objects in the data model (e.g., those in the data object list 610) that is specified to the AI/ML model 132. In a subsequent request, with the error pointed out to the AI/ML model 132, the AI/ML model 132 may be able to determine that an item semantically similar or conceptually similar to revenue is present, as the data object titled “Sales. ”

In some implementations, the computer system 110 can use the context of the conversation in a chatbot interface to resolve ambiguities or supplement missing data in a user prompt. For example, after creating one metric, a user may with shorthand refer to the previous metric and specify a variation of it. For example, after creating a metric that included an aggregation of sales over time periods, the user may state, “create another metric but aggregated by category. ” Taking into account the previous metric created and previous user prompts or other context of the conversation, the computer system 110 and/or the AI/ML model 132 can determine that the user intends to create another aggregation of the same sales data object used before, aggregated by category as specified in the most recent prompt. In many other situations the context of previous interactions in a session or previous interactions by the user can fill gaps of missing information or provide additional confidence to the generation output of the AI/ML model 132.

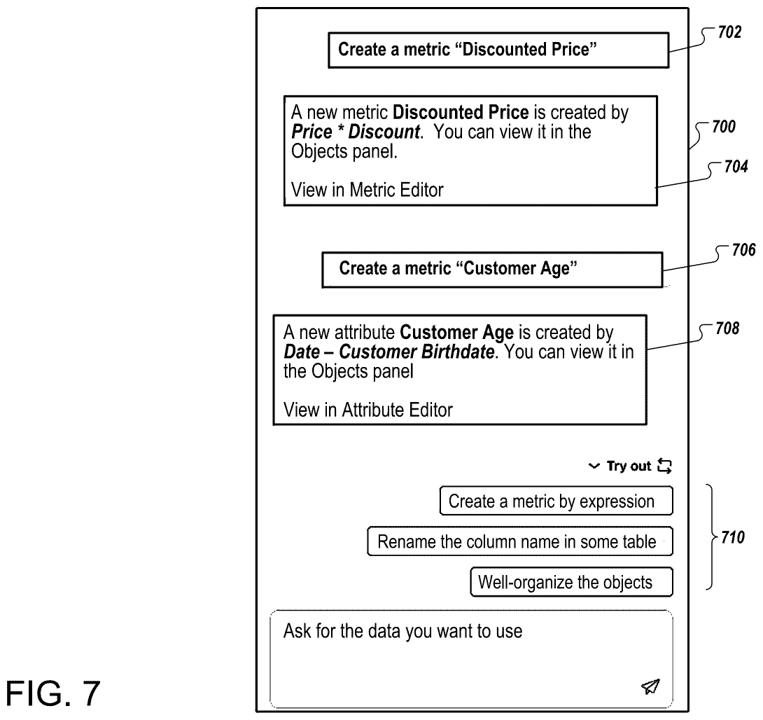

FIG. 7 shows another example user interface 700 for creating data objects using a chatbot interface. It shows a first user prompt 702 and a corresponding response 704 showing the new metric created and other related information. The user interface 700 also shows a second user prompt 706 and a corresponding response 708 showing that a new attribute has been created as requested by the user. This shows how the computer system 110 can enable a variety of different types of data object to be created, e.g., metrics, facts, attributes, etc., using the techniques described herein. The user interface 700 also shows suggested prompts 710 that show actions that the computer system 110 can perform for the user to manage or improve the data model that is being edited.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
storing, by the one or more computers, records describing each of a plurality of different functions that can be performed in a data processing system;
receiving, by the one or more computers, a user prompt that indicates a type of data object to be created;
selecting, by the one or more computers, records for a subset of the functions based on the user prompt;
sending, by the one or more computers, a request to be processed by one or more artificial intelligence and/or machine learning (AI/ML) models, wherein the request includes (i) the user prompt, (ii) the selected records for a subset of the functions, and (iii) data indicating data objects for one or more data sets;
receiving, by the one or more computers, output of the one or more AI/ML models that defines an additional data object, wherein the output (i) refers to one or more of the data objects indicated in the request and (ii) specifies a relationship for calculating a value of the additional data object based on one or more values of the one or more of the data objects; and
using, by the one or more computers, the output of the one or more AI/ML models to cause a user interface to be updated to indicate the additional data object or to update a data model for the one or more data sets to include the additional data object.

2. The method of claim 1, wherein the user prompt is a text instruction or request to create a metric, and the user prompt indicates a type of data for the metric to represent.

3. The method of claim 1, wherein storing the records comprises storing, in a vector database, a separate record for each of the different functions; and
wherein selecting the records for the subset of the stored functions comprises selecting a subset of the records based on vector similarity for one or more portions of the user prompt and one or more portions of the records.

4. The method of claim 1, wherein the relationship for calculating the value of the additional data object comprises a formula or expression.

5. The method of claim 4, wherein the formula or expression specifies a mathematical operation to be performed on data of one or more data objects for the one or more data sets.

6. The method of claim 1, wherein the records for the plurality of different functions indicate, for each function, syntax for the function and arguments or inputs for the function.

7. The method of claim 6, wherein the records for the plurality of different functions indicate, for each function, an operator or symbol for the function and a description of the function's effect.

8. The method of claim 6, wherein the records for the plurality of different functions indicate, for each function, one or more examples of correct usage of the function.

9. The method of claim 8, wherein the one or more examples for a function include one or more pairs of requests and resulting valid formulas generated using the function.

10. The method of claim 1, wherein the request includes an additional instruction to provide a name, description, and formula for the additional data object; and
wherein the output of the one or more AI/ML models includes a name for the additional data object, a description of the additional data object, and a formula for calculating values of the additional data object.

11. The method of claim 1, wherein the request includes an instruction to generate the additional data object using the data objects indicated in the request, which are data objects in a data model for the one or more data sets, and not rely on data objects that are not in the data model.

12. The method of claim 1, wherein the request includes an instruction to select one of the functions indicated in the request and use the selected function to generate the additional data object.

13. The method of claim 1, comprising:
performing, by the one or more computers, a validation process for the additional data object indicated by the output;
determining, based on the validation process, that the additional data object does not satisfy one or more rules or criteria for data objects; and
in response to the determination, initiating an additional interaction with the one or more AI/ML models to request a correction or adjustment to the additional data object.

14. A system comprising:
one or more computers; and
one or more computer-readable media storing instructions that are operable, when executed by the one or more computers, to cause the one or more computers to perform operations comprising:
storing, by the one or more computers, records describing each of a plurality of different functions that can be performed in a data processing system;
receiving, by the one or more computers, a user prompt that indicates a type of data object to be created;
selecting, by the one or more computers, records for a subset of the functions based on the user prompt;
sending, by the one or more computers, a request to be processed by one or more artificial intelligence and/or machine learning (AI/ML) models, wherein the request includes (i) the user prompt, (ii) the selected records for a subset of the functions, and (iii) data indicating data objects for one or more data sets;
receiving, by the one or more computers, output of the one or more AI/ML models that defines an additional data object, wherein the output (i) refers to one or more of the data objects indicated in the request and (ii) specifies a relationship for calculating a value of the additional data object based on one or more values of the one or more of the data objects; and
using, by the one or more computers, the output of the one or more AI/ML models to cause a user interface to be updated to indicate the additional data object or to update a data model for the one or more data sets to include the additional data object.

15. The system of claim 14, wherein user prompt is a text instruction or request to create a metric, and the user prompt indicates a type of data for the metric to represent.

16. The system of claim 14, wherein storing the records comprises storing, in a vector database, a separate record for each of the different functions; and
wherein selecting the records for the subset of the stored functions comprises selecting a subset of the records based on vector similarity for one or more portions of the user prompt and one or more portions of the records.

17. The system of claim 14, wherein the relationship for calculating the value of the additional data object comprises a formula or expression.

18. The system of claim 17, wherein the formula or expression specifies a mathematical operation to be performed on data of one or more data objects for the one or more data sets.

19. The system of claim 14, wherein the records for the plurality of different functions indicate, for each function, syntax for the function and arguments or inputs for the function.

20. One or more non-transitory computer-readable media storing instructions that are operable, when executed by the one or more computers, to cause the one or more computers to perform operations comprising:
storing, by the one or more computers, records describing each of a plurality of different functions that can be performed in a data processing system;
receiving, by the one or more computers, a user prompt that indicates a type of data object to be created;
selecting, by the one or more computers, records for a subset of the functions based on the user prompt;
sending, by the one or more computers, a request to be processed by one or more artificial intelligence and/or machine learning (AI/ML) models, wherein the request includes (i) the user prompt, (ii) the selected records for a subset of the functions, and (iii) data indicating data objects for one or more data sets;
receiving, by the one or more computers, output of the one or more AI/ML models that defines an additional data object, wherein the output (i) refers to one or more of the data objects indicated in the request and (ii) specifies a relationship for calculating a value of the additional data object based on one or more values of the one or more of the data objects; and
using, by the one or more computers, the output of the one or more AI/ML models to cause a user interface to be updated to indicate the additional data object or to update a data model for the one or more data sets to include the additional data object.
